(19) United States
(12) Patent Application Publication
(10) Pub. No.: US 2005/0228739 A1
(43) Pub. Date: Oct. 13, 2005

(54) Financial instrument trading system, method and computer program product

(75) Inventor: Steve Leibowitz, Las Vegas, NV (US)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: Hotspot FX Inc.

(21) Appl. No.: 10/821,118

(22) Filed: Apr. 8, 2004

(51) Int. Cl. G06F 17/60

(52) U.S. Cl. 705/37

(57) ABSTRACT

A computerized trading system for facilitating transactions of financial instruments between a plurality of traders. A bid and offer recorder records bids and offers on financial instruments from traders. A matching engine is configured to match complementary bids and offers. A trade restrictor is configured to detect bids and offers that are automatically entered and restrict matching of the bids and offers by the matching engine. The trade restrictor may block trades between traders where both the bids and the offers are based on automated price feeds, encouraging banks to supply such automated price feeds and enhance the liquidity of the market. Price feed based trades can be detected by locating data in the bid or offer indicating automation or from the structure of the bid or offer, which may also contain a cancellation request for a previous bid or offer made within a short time period.

### BACKGROUND OF THE INVENTION

1. Field of the Invention

The present invention is related to systems, methods and computer program products to match trades for financial transactions between buyers and sellers, and more particularly to systems, methods and computer program products that can selectively restrict trades between traders.

2. Description of Related Art

Foreign exchange trading often involves the use of substantial credit or margin to allow the purchase of large amounts of currency. Existing computer systems for matching foreign exchange bids and offers often confirm that sufficient credit is available between parties prior to matching a bid and an offer. If sufficient credit is not available between the parties, the trade is blocked.

For example, U.S. Pat. No. 5,375,055 to Togher et al. (“Togher”) discloses an electronic trading system interconnecting a plurality of trader workstations WS for facilitating the buying and selling of large blocks of foreign currency, as shown in FIG. 1 of Togher. Subgroups of the plurality of trader workstations are attached to market access nodes MAN which are under the control of an administrator (e.g., a bank) and maintains transaction records, credit limits and other confidential information, as described at column 5, lines 10-15 of Togher. Arbitrator nodes ARB identify matches between buyers and sellers, as described at column 5, lines 25-30 of Togher.

Each of the market access nodes contains detailed credit information on potential traders. The credit information indicates the amount of credit a particular market access node is willing to extend to each possible counterparty trader, as described at column 2, lines 48-57 of Togher. These credit limits are used to create preauthorization matrices which indicate simple yes or no answers as to whether credit is available between potential counterparties, as shown in FIG. 6 of Togher. In one aspect, Togher discloses that the arbitrator node can display an offer or bid as dealable to the workstation, but allow the respective market access node to block the above limit portion of the trade. In another aspect, the entire trade may be blocked, as described at column 3, lines 1-10 of Togher. Ostensibly, maintaining of the more detailed credit information only on at the market access node preserves the anonymity of the traders.

U.S. Patent Application Publication No. 2003/0088499 to Gilbert et al. (“Gilbert”) discloses an electronic trading system 101 having local workstations 102 and remote workstations 104 connected via networks 108 and 110 to a processor 106, as shown in FIG. 1 of Gilbert. Bids and offers submitted by the workstations are communicated over the networks to the processor to be ranked and stored in a bid and offer queue, as described in paragraph 25 of Gilbert. These bids and offers are sent to a display 200 that is associated with an interface 300 which is presented on a trader's workstation for hitting or lifting.

Traders acting at one of the workstations as a broker trader, on behalf of a principal trader, are subject to a special designation and limitations by the trading system. For example, a trader acting for a principal may be permitted to hit bids of broker traders only when those broker traders are representing certain principals, as described in paragraph 32 of Gilbert. FIG. 5 of Gilbert illustrates a process 500 for the setting switches by the principal to selectively limit trades with various counterparties. The process displays bids and offers with color coding, or other indications, that a bid or offer is or is not available based on those switches, as described at paragraph 44 of Gilbert.

Despite the ability of the financial trading system of Togher to block trades based on credit information and the financial trading system of Gilbert to block trades based on a counterparty's identity, further centralized controls over trading are needed, especially on systems for facilitating the exchange of foreign currencies. At the same time, due to the generally decentralized market for foreign currencies when compared with securities such as stocks and bonds, any limitations to the trading of currencies by a foreign currency exchange trading system need to be carefully balanced so as to not interfere an undue amount with the liquidity and depth of the market hosted by the system.

Therefore, it would be advantageous to have a system for facilitating the exchange of financial instruments that can exercise further controls over the trading of financial instruments, especially the trading of foreign currencies. In addition, it would be advantageous if the controls optimized and enhanced the liquidity of the market hosted by the system, especially the liquidity of a foreign currency exchange market.

### BRIEF SUMMARY OF THE INVENTION

The present invention addresses the above needs and achieves other advantages by providing a computerized trading system for facilitating transactions of financial instruments between a plurality of traders. The computerized trading system includes a bid and offer recorder for recording bids and offers on financial instruments from traders. A matching engine is configured to match complementary bids and offers. A trade restrictor of the computerized trading system is configured to detect bids and offers that are automatically entered, such as bids and offers entered via an automated price feed, and restrict matching of the bids and offers by the matching engine. For instance, the trade restrictor may block trades between traders where both the bids and the offers are based on automated price feeds in order to encourage market makers to supply such automated price feeds and enhance the liquidity of the market. Bids and offers based on automated price feeds can be detected by locating data in the bid or offer indicating automation or from the structure of the bid or offer, which may also contain a cancellation request for a previous bid or offer made within a short time period.

In one embodiment, the present invention includes a computerized trading system for facilitating transactions of financial instruments between a plurality of traders. The computerized trading system includes a bid and offer recorder, a matching engine and a trade restrictor. The bid and offer recorder is connected in communication with the traders and is configured to record bids and offers from the traders. Each of the bids and offers include transaction information, such as the price, quantity and type of financial instrument that is being bid for or offered. Connected in communication with the bid and offer recorder is the matching engine. From the bid and offer recorder the matching engine receives the bids and offers, and the transaction information associated with each. The matching engine is configured, via logic implemented by hardware, software, firmware, etc., to compare the bids and the offers and to match the bids and the offers. For instance, matches may be made between bids and offers for the same financial instrument based on the price of the bids and the offers. Connected in communication with both the bid and offer recorder and the matching engine, is the trade restrictor. The trade restrictor receives the bids and the offers from the bid and offer recorder and is configured to determine which of the bids and offers are automated. Once the automated bids and offers are identified, the trade restrictor is configured to restrict matching of automated bids and offers by the matching engine.

The transaction information may also include a source identity that identifies the party placing the bid or the offer. This information can be used by the trade restrictor to block, or otherwise inhibit, specific counterparties from matching irrespective of the automatic feed criteria. In the case where the automated bids and/or offers are generated using an automated price feed from another trading platform, restricting or blocking trades between financial institutions when both of the institutions are using automated price feeds avoids matching of bids and offers meant to provide liquidity to individual traders.

In another aspect, the transaction information of each of the bids and the offers includes automation data indicating that the bid or offer is automated. In this case, the trade restrictor is configured to find the automation data within the transaction information and to correlate the information with stored definitions of the automation data. This automation data is then used to block matching of bids and offers each having the automation data.

Alternatively, the trade restrictor can be configured to determine whether bids or offers are automated by analyzing the structure of the bids and offers. For instance, the trade restrictor may check for data in a bid or offer that requests cancellation of a previous bid or offer, especially if the new bid or offer is within a minimal time period.

Restricting of bid and offer matches can be either done prospectively by refusing to record or post such bids and offers to the trading platform, or by restricting matching by the matching engine of the automated bids and offers, or even by blocking matched bids and offers from clearing.

The present invention has many advantages. For example, the trade restricting system inhibits, or blocks, trading on automated price feeds by other market makers or other automated price feeds. Such selective control over trading between market makers and automated price feeds actually increases the liquidity and depth of the market for individual traders. In addition, blocking of trading market makers, particularly in the case of automated price feeds, provides an incentive for banks to provide automated price feeds, further increasing liquidity and depth of the trading platform.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 is a schematic of a computerized trading system of one embodiment of the present invention;

FIG. 2 is a collection of GUIs, including trade entry, open positions, deal log and credit GUIs, generated by the computerized trading system of FIG. 1;

FIG. 3 is a bid box generated by the computerized trading system of FIG. 1;

FIG. 4 is an offer box generated by the computerized trading system of FIG. 1;

FIG. 5 is a lift window generated by the computerized trading system of FIG. 1;

FIG. 6 is a trade confirmation window generated by the computerized trading system of FIG. 1;

FIG. 7 is an average log screen generated by the computerized trading system of FIG. 1 and displaying an all deals tab;

FIG. 8 is the average log screen of FIG. 7 displaying an averaging tab;

FIG. 9 is the average log screen of FIG. 7 displaying a final tab;

FIG. 10 is a re-price balance window generated by the computerized trading system of FIG. 1;

FIG. 11 is a single layer feed message generated by the computerized trading system of FIG. 1;

FIG. 12 is a multi-layer feed message generated by the computerized trading system of FIG. 1;

FIG. 13 is a flow diagram of operation of a trading platform of the computerized trading system of FIG. 1; and

FIG. 14 is a schematic of a trading platform of another embodiment of the present invention.

### DETAILED DESCRIPTION OF THE INVENTION

The present inventions now will be described more fully hereinafter with reference to the accompanying drawings, in which some, but not all embodiments of the invention are shown. Indeed, this invention may be embodied in many different forms and should not be construed as limited to the embodiments set forth herein; rather, these embodiments are provided so that this disclosure will satisfy applicable legal requirements. Like numbers refer to like elements throughout.

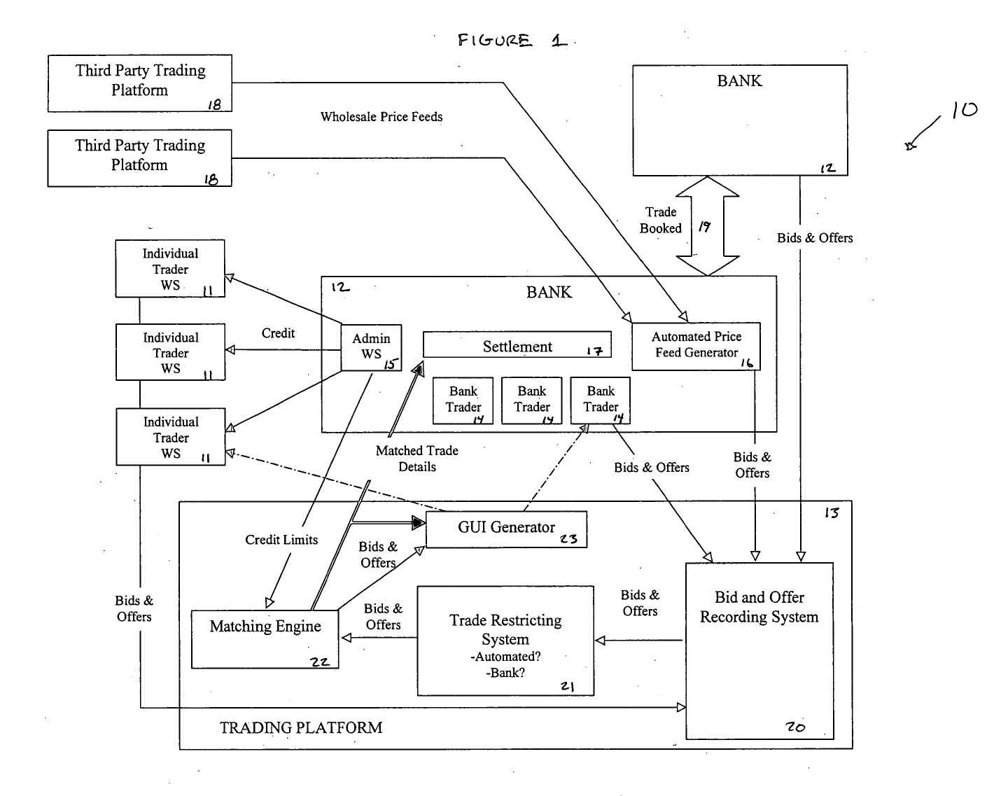

A computerized trading system 10 of one embodiment of the present invention is shown in FIG. 1. The computerized trading system includes a plurality of individual trader workstations (WS) 11 and a plurality of bank computer systems 12 electronically connected to a computerized trading platform 13. Generally, groups of the trader workstations 11 are associated with a respective one of the bank computer systems 12 which extend credit to the traders of each of their workstations allowing them to submit bids and offers for financial instruments on the trading platform 13. The trading platform provides the trader workstations 11 and the bank computer systems 12 with information on the bids and offers of other trader workstations and bank computer systems, and matches bids with offers so as to facilitate closing of matched bids and offers for the financial instruments.

The term “bank” as used herein denotes generally any institution, individual, firm or other entity that has sufficient resources to extend credit to traders for use in trading financial instruments. For instance, the bank can be a brokerage, a lending institution, or a trusted individual with known financial resources. The term “financial instruments” as used herein denotes any type of property, such as stock, bonds, futures, derivatives, foreign exchange contracts, commodities, golf memberships, collectibles, etc., or any other property interest, real, intangible or otherwise, that can be exchanged for consideration. It should be also noted that the term “network” as used herein should be construed broadly to include all types of electronically assisted communication such as wireless networks, local area networks, wide area networks, public networks such as the Internet, public telephone networks, or various combinations of different networks.

Referring again to the embodiment of FIG. 1, each of the bank computer systems 12 has a collection of computers interconnected via a network, such as a local area network, including a plurality of bank trader workstations 14, one (or more) administrative workstations 15, an automated price feed generator 16 and a settlement system 17. Generally, each bank computer system, and the component computer systems thereof, are connected in electronic communication over one or more networks (represented by the lines indicating exemplary flows of data) to the other computer systems of the computerized trading system 10. In one aspect, communication may be facilitated by the computerized trading platform 13 providing an application programming interface (API). The API includes a template defining the format of communication messages and a library of functions that are made accessible to the other computer systems.

Preferably, the bank trader workstations 14 are computers that are connected in communication (e.g., connected in electronic communication, such as a via a network) with the trading platform 13 and are capable of displaying a plurality of graphical user interfaces (GUI) that allow the bank traders to interact and exchange information with the trading platform. These GUIs, for instance, allow the bank traders to submit bids and offers, and to receive and display the bids and offers of other traders, information on completed trades, open positions and credit exposures. The various GUIs for interacting with the trading platform will be described in more detail below.

The administrative workstations 15 are also computers connected in communication with the trading platform 13 and are configured to manage credit limits and enablement of the traders associated with its bank and that bank's individual trader clients. For instance, the administrative workstation 15 can record and send information, using various GUIs, describing credit limits for each of its individual trader workstations 11 and bank trader workstations 14 to the trading platform 13, as indicated by the solid line of FIG. 1. In addition to changing the credit limits of its own trader workstations, the administrative workstations 15 can send information to the trading platform 13 for setting and changing the credit limits extended to other banks and traders. Typically, in the system of the present invention, credit limits are not set for the traders of other banks, only the other banks, so that the anonymity of the traders can be preserved.

The administrative workstations 15 are also configured to control access to the trading platform 13 by the workstations 11, 14. For instance, the administrative workstations 15 can disable an individual workstation 11 so that the individual trader can view trade information, but cannot trade using the trading platform 13, or can neither view information, nor trade using the trading platform. Credit and enablement information are preferably stored on servers or other computers of the trading platform for use thereby in controlling access to the platform and the matching of bids and offers.

In the embodiment illustrated in FIG. 1, the automated price feed generator 16 is a computer system connected in communication with one or more third party trading platforms 18, from which can be obtained continuous wholesale pricing data on one or more financial instruments. The automated price feed generator 16 is configured to apply various formulae developed by the bank to the wholesale price feed to generate an automated price feed of bids and offers for use on the trading platform 13. Typically, the automated price feed generator takes the bids and offers from other markets and adds some type of a spread that allows offsetting transactions to be made by the bank in the two markets to capture the value of the spread. The automated price feed generator 16 is also connected in communication with the trading platform 13, such as via a network, allowing the transmission of the automated bids and offers to the trading platform, as shown by FIG. 1.

Alternatively, the automated price feed generator 16 can be configured to automatically generate bids and offers without the use of wholesale price feed data from third party platforms. For instance, the market making bank can use internal data, or various analytical processes, to generate a price feed without other price feed inputs.

Also, the price feed could be generated by outside inputs other than wholesale price feeds, such as by using information on world events, interest rates, etc. Regardless, the term “automated” or “automated price feed” as used herein refers to any at least partially machine-generated series of bids and/or offers.

Advantageously, these automated price feeds provide additional depth of market for the individual trader workstations 11 and revenue for the banks who are acting as market makers. However, dealing by one bank on the automated price feeds of another bank can cause problems. The automated price feeds hosted by the bank are motivated in part by wanting to provide liquidity to the market. However, the price feeds of one bank can lag another bank, resulting in matching of the bank's price feeds and reducing the liquidity of the market. Also, dealing on the price feeds by bank trader workstations 14 may cause problems due to the competitive nature of the relationship between the banks. The computerized trading system 10 of the present invention has, in part, been developed to avoid this situation by selectively restricting market maker-to-market maker trading and/or trading on automated price feeds between market makers, i.e., to restrict trading based also on participant type or identity. This provides liquidity to the traders, but avoids giving market makers access to the liquidity of other market makers. Notably, not all banks will include the automated price feed generator 16, as some banks will not act as market makers, or will manually supply bids and offers as a market maker. Therefore, the present system may also restrict transactions between market makers on non-automated bids and offers.

The settlement system 17 is connected in communication with the trading platform 13 and receives details on matched trades therefrom. This information is used by the settlement system 17 for clearing purposes, wherein the trades are actually completed at the prices, quantities, and other terms, of the matched bids and offers, as is indicated by the arrow 19 marked “trade booked” between the bank computer systems 12, as shown in FIG. 1. Matched trade details can also be sent by the settlement system 17 to the various trader workstations 11, 14 for display thereon, or the matched trade details can be received directly from the trading platform 13, or via other, less direct sources. It should be noted that although booking of trades is implemented in the above-described embodiment, trades could be booked directly between individuals, with clearinghouses, etc., and still be within the scope of the present invention.

Notably, the settlement system may involve the use of non-electronic, non-computer systems to complete the final transfer of ownership to the financial instruments and consideration therefore. Similarly, each of the systems described herein, in various embodiments, may include a collection of manual and automated processes and components. To this end, the term “computerized” as used herein denotes the use of various electronic and automated processes, but not necessarily an entirely electronic and automated process.

As shown in FIG. 1, the trading platform 13 of the computerized trading system 10 includes a bid and offer recording system 20, a trade restricting system 21, a matching engine 22 and a GUI generator 23. The bid and offer recording system 20 is configured to receive the bid and offer information submitted by the individual trader workstations 11, the bank trader workstations 14 and the automated price feed generator 16. The bid and offer recording system 20 is also configured to communicate the bid and offer information to the trade restricting system 21.

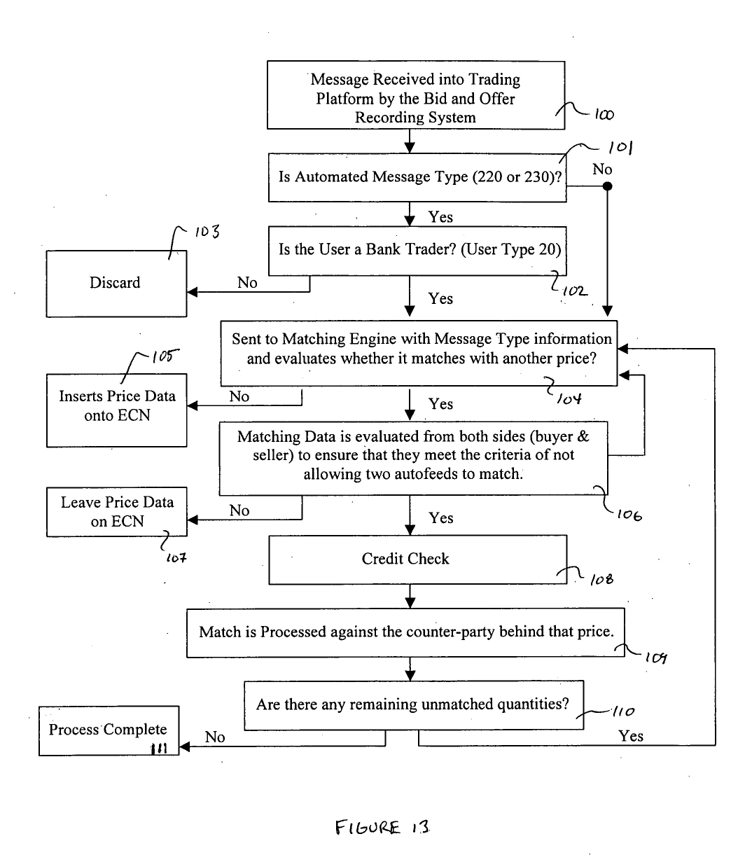

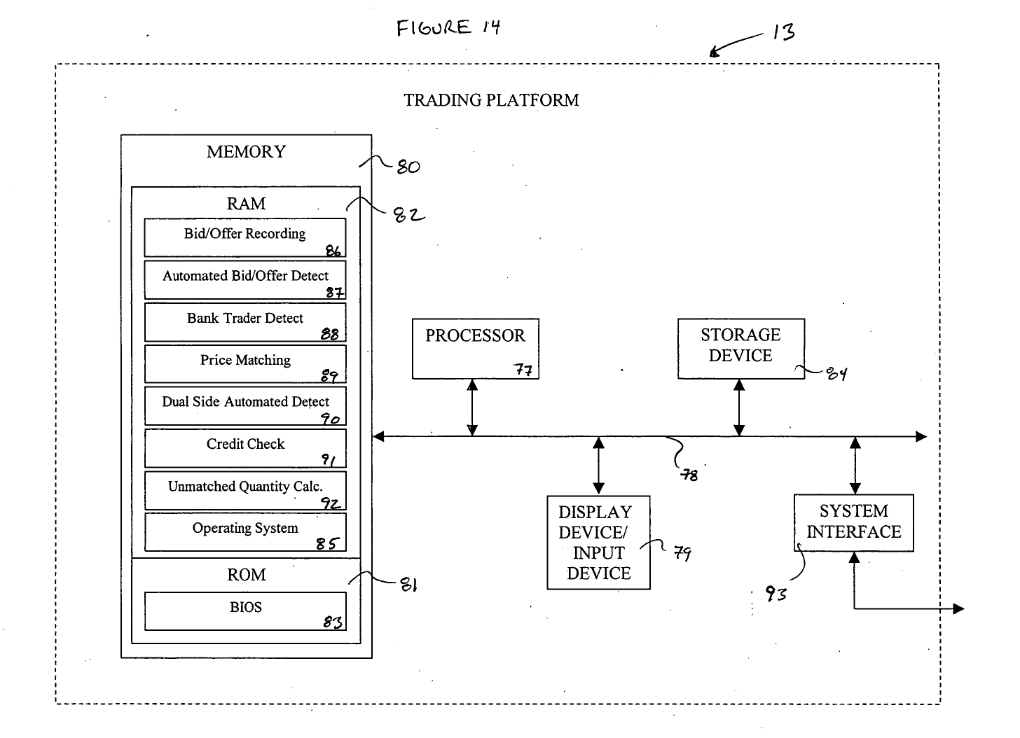

Preferably, the bid and offer recording system 20 works in coordination with a plurality of GUIs generated by the GUI generator 23 and used to prompt and record various bids and offers from the individual and bank traders, as shown by block 100 of the flow chart of FIG. 13. It should be noted that GUIs are not necessarily involved in submitting the automated bids and offers to the bid and offer recording system 20, although GUIs are often employed to monitor and generate such automated bids and offers. Further, the GUIs may be generated and associated with the bank computer systems 12, or the workstations 11, 14, and therefore the bid and offer recording system 20 and the trading platform 13 only see bid and offer messages, and not any GUIs associated therewith. Regardless of how they are generated, the bids and offers are preferably electronic messages in a standardized format once they reach the recording system 20, or the recording system is configured to convert them to a standardized format for communication to the other platform systems, such as the formats illustrated in FIGS. 11 and 12.

The single-layer feed message format illustrated in FIG. 11, includes an alphanumeric string which has several fields separated by pipes “|”. These fields include, in order, a message type field (1), an account field (2), a user identification field (3), an instrument identification field (4), a bid cancellation field (5), an offer cancellation field (6), a new bid request field (7), a new bid price field (7a), a new bid quantity field (7b), a new bid show quantity field (7c), a new offer request field (8), a new offer price field (8a), a new offer quantity field (8b), and a new offer show quantity field (8c).

The single-layer feed message is designed so that automatically generated price feeds don't build up over time and stay at a single layer. The single-layer feed message format is configured to do this by providing for cancellation of previous bids and offers via the bid cancellation field (5) and the offer cancellation field (6). If the cancellation fields (5) and (6) are zero, then no cancellation is made. If other than zero, then additional price (a), quantity (b) and show quantity (c) fields are generated to facilitate identification of the bid or offer to be cancelled. The other fields, as is evident from their names, identify the type of message as a bid or offer generated by automation (220 or 230), the account on which the deal is made, the trader making the trade, the financial instrument (e.g., the currency pair), and the price, quantity and reserve quantity for the new bid or offer.

Multi-layer feed messages, on the other hand, allow for submission of multiple bids and offers and don't provide for cancellation of previous offers, as shown in FIG. 12. As a result, previous bids and offers remain on the trading platform 13 for matching by the matching engine 22. Fields (1) through (4) are the same for the multi-layer feed as the single-layer feed. The multi-layer feed message format includes a number of requests field (5) that identifies the number of bids or offers to follow, which, in the illustrated example, is equal to two. As is indicated by the number of requests field (5) two groups of fields each include a buy/sell identification field (a), a request identification field (b), a price field (c), a quantity field (d) and a show quantity field (e). The number of requests field, however, can be include a single group or more than two groups.

The trade restricting system 21 is configured to determine whether the bids or offers are automated, for the purposes of selectively restricting matching between automated and market maker bank-originated bids and offers. Referring again to FIG. 13 for example, if the message formatting standards used above are employed, the trade restricting system is configured to receive the electronic bid/order message, parse the message and check field (1) to determine if it holds 220 or 230 which indicates a single-layer or multi-layer automated price feed, as shown by block 101. If not an automated bid or offer, the trade restricting system 21 is configured to send the bid or offer message directly to the matching engine 22.

The trade restricting system 21 can also be configured to determine whether the bid/offer message has been manually submitted by one of the bank trader workstations 14 by comparing the username in field (3) of the bid/offer message to a list of known bank traders, or by use of a code indicating a bank trader (user type 20), as shown by block 102 of FIG. 13. If the trader is not a bank trader, the trade restricting system 21 is configured to discard the bid/offer message, as shown by block 103. If the trader is a bank trader, the trade restricting system 21 is configured to forward the bid/offer message to the matching engine 22 for matching with another price, as shown by block 104.

The matching engine 22 is configured to receive the bid/offer message (block 104) and determine whether the bid or offer matches another bid or offer based on price. For instance, the matching engine is configured to execute the newly received bid or offer with previously placed orders on the opposite side of the market with a price equal to, or better than, the price of the newly received bid or offer.

If no matches are found, the matching engine 22 is configured to send the unmatched bids and offers to the GUI generator 23 for display on various trader workstations 11, 14, as shown by block 105 and FIG. 1. If a match is found, the matching engine 22 is configured to reconfirm that at least one of the bid and the offer are not automated, as shown by block 106, either by re-checking field (1) in both bid/offer message, or by sending the messages to the trade restricting system 21.

If both bid and offer are automated, then the original order is kept on display for the workstations 11, 14 (as shown by block 107) and the bid/offer message is sent back to block 105 for another attempt at matching, as shown by FIG. 13. If one of the orders is not automated, then the matching engine 22 is configured to run a credit check (as shown by block 108) on the bid and offer to see if credit limits between the banks are exceeded and to see if the credit limits associated with the workstations placing the orders have been exceeded. If the match is within all credit limits, the matching engine 22 is configured to process the match (as shown by block 109) and send the matched trade details to the respective bank settlement systems 17 and to the GUI generator 23 for possible averaging and processing by the trader using an optional averaging function, which is described in more detail below. Notably, the trade restricting system 21 can also be configured to selectively block or inhibit matching of manually placed, bank originated bids and offers with automatically generated bids and offers. Further, the trade restricting system could also be configured to selectively block or inhibit market maker to market maker transactions. The trade restricting system 21 in another aspect may restrict matching of trades below or above certain quantities for selected trader identities.

After the match has been found and approved, the matching engine 22 is configured to calculate (such as by using quantity field (d) on the bid and offer) if there is an unmatched quantity, as shown by block 110. This unmatched amount of the bid or offer is routed back to block 104 for further matching. Note this may similarly happen if either the bid or the offer have reserve quantities, as would be indicated by a smaller amount in the show field (c) of the bid/offer message. If the quantities of both the bid and offer match (an there is no reserve quantity), then the matching engine closes out the process, as shown by block 111.

It should be noted that detection of automated trade requests is not limited to above-described parsing of a bid/offer message to find some designator or flag indicating automation. The trade restricting system 21 of the present invention may be configured to detect automated and bank originated bids and offers in many ways and still be within the purview of the present invention. For instance, the trade restricting system may be able to examine the characteristics of a requested bid or offer and deduce that it is an automated bid or offer, such as by the presence of cancellation data, the delay between the bid or offer and previous similar bids or offers. Advantageously, such systems could be employed to screen bids and offers with varying formats other than those illustrated in FIGS. 11 and 12. Also notable, is that the trading restricting system could be configured to inhibit automated trades in other ways, such as by inquiring with the trading parties as to whether to match the trade, slowing matching of the trades, etc.

Preferably, bids, offers and other transaction information are displayed by, and recorded from, the trader workstations using a collection of trading GUIs of the present invention. Preferably, these GUIs are generated by a combination of hardware and software of the workstations 11, 14 and the trading platform 13 distributed so as to maximize the speed of data transmission between the systems. However, the GUIs can be generated in a number of ways using various networks, software, hardware and other components as described above. For simplicity however, the GUI generator 23 is illustrated in FIG. 1 as residing on the trading platform 13.

An exemplary embodiment of the GUIs of the present invention, in the context of facilitating currency trading, are shown in FIGS. 2-13. For instance, the trading platform GUIs can include a trade entry screen 25, an open positions screen 26, a deal log 27 and a credit screen 28, as shown in FIG. 2.

The trade entry screen 25 includes one or more rows, each of which displays information for a particular currency pair (e.g., EUR/USD and USD/JPY). Each of the rows includes a dealing area in its center which is separated into a bid side (left) and an offer side (right). An innermost pair of boxes includes a best bid price box 29 on the left and a best offer price box 30 on the right. These price boxes display the best bid and offer available to the trader and clicking on one of the price boxes allows the trader to hit or lift the best bid or offer.

Upon clicking on the best bid or offer price boxes 29, 30, a hit/lift window 41 appears, as shown in FIG. 5, unless the single or double-click dealing mode described below is employed, in which case the hit/lift window 41 is skipped. The hit/lift window is labeled “sell” if the trader hit the bid, or is labeled “buy” if the trader lifted the offer. The hit/lift window 41 shows a price 42 and an amount 43 at which the trader will be dealing, which is the best bid or offer at the time the price box 29 or 30 was hit. A send button 44 allows the trader to submit the bid or offer to the bid and offer recording system 20. In another option, the trader workstation may be configured so that a single or double click on the best bid or offer price boxes 29, 30 immediately sends the offer without displaying the hit/lift window. In which case, a trade confirmation window 45 will be immediately displayed, as shown in FIG. 6. It should be noted that the terms “bid” and “offer” as used herein denote all types of bids and offers and therefore encompass hits and lifts.

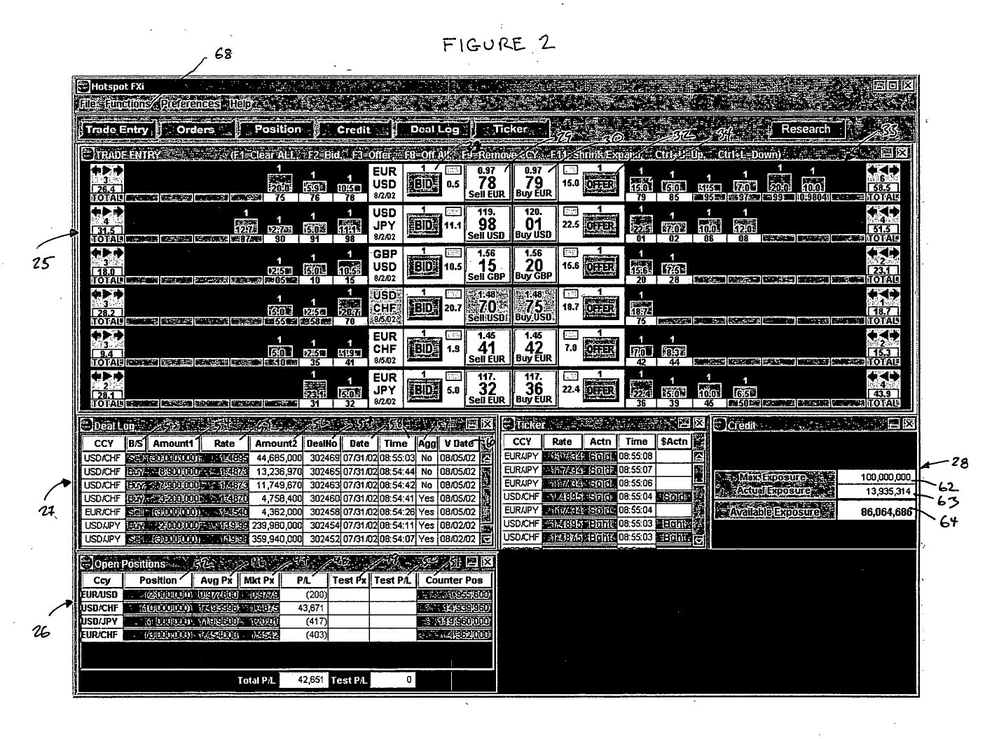

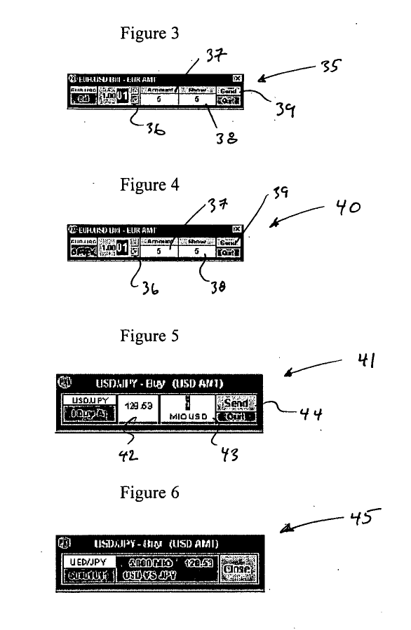

Adjacent to the price boxes on either side are a bid button 31 (left side) and an offer button 32 (right side). Selecting these buttons allows the trader to enter a new bid or offer, respectively, such as by opening a bid box 36 or an offer box 40, as shown in FIGS. 3 and 4, respectively. In the best bid box appears the current market price with the cursor over the smallest increments. Up and down arrows 36 allow adjustment of the bid price. Clicking or tabbing on a white amount box 37 allows the amount to be changed. A reserve amount can be set by selecting and changing a show box 38. Otherwise, the show box will default to the amount in the amount box 37. Clicking on a send button 39 submits the bid to the bid and offer recording system 20. The offer box 40 operates with all the same functionality of the bid box 36, except that an offer is being made.

Each of the rows of the trade entry screen 25 also contains market information areas 33 that are on either side of the buttons 31, 32. On the left, the market information area shows bid information, while the market information area on the right shows offer information. The market information includes the number of orders and total amount of all the orders at a particular price and currency pair. Orders placed by the trader workstation on which the trade entry screen 25 is being shown, are shown in yellow. Prices in the market information areas 33 that are within 10 points of the best price are shown in a white background and if more than 10 points from the best price are shown in a black background. Vertical bars 34 are scaled to the amount available at that price, with a numeric indication is inside the bars while the number of participants making up a bid or offer is indicated above the vertical bar. Optionally, the vertical bars may also be color coded to reflect the total amount. As another option, trades that have been restricted by the trade restricting system 21 may be displayed, but not accessible for hitting and lifting by bank trader workstations 14. For instance, automated price feeds from other banks may be displayed on the bank trader workstation in gray to indicate inaccessibility.

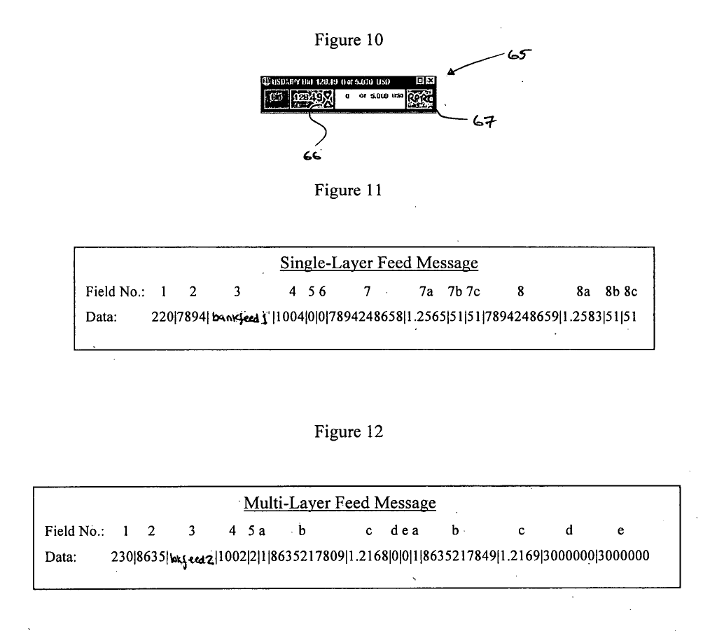

FIG. 10 illustrates a re-price balance window 65 which is displayed when the trader selects the order placed from the workstation (displayed in yellow) in the market information areas 33. The re-price balance window 65 includes up and down arrows 66 next to a display of the price of the original bid or offer and a re-price button (RPRC) 67. The up and down arrows 66 allow the price for the remaining balance of a bid or offer to be changed, and hitting the re-price button 67 submits this change to the bid and offer recording system 20.

In the embodiment illustrated above, the change is submitted as a message (such as the messages shown in FIGS. 11 and 12) containing the new price for the remaining quantity and cancellation instructions for the previous bid or offer. The advantage of using the re-price function is that a new bid or offer is submitted and replaces the original bid or offer for the remaining outstanding quantity of the bid or offer without having to cancel the previous bid or offer, calculate the remaining balance manually and then submit a new bid or offer. Notably, if none of the quantity of the bid or offer has been matched, then essentially the entire bid or offer has been repriced.

Referring again to FIG. 2, the open positions screen 26 lists current obligations of the trader by currency pair and also includes a plurality of data fields aligned with each currency pair including a position field 52, an average price field 46, a market price field 47, a profit/loss field 48, a test price field 49, a test profit/loss field 50 and a counter position field 51. Displayed in the position field 52 are the current long or short obligations for that currency pair for the trader. The average price field 46 indicates the average price for all deals transacted for the currency pair for that trading day. In the market price field 47, the market price for that currency is displayed.

The profit/loss field 50 is configured to display a calculated difference in the price at which the position was established and the current market price for the position, i.e., the profit or loss on the position if it were closed at the current price. In response to entry into the test price field 49 of a hypothetical price, the test profit/loss field 50 is configured generate a theoretical profit or loss on the position based upon that price. In other words, it allows the trader to see what the affect on his position would be if the market were to move to different levels. This is similar to the profit/loss field 50 but using the hypothetical price. The counter position field 51 shows the equivalent amount of the secondary currency, long or short.

The deal log 27 also includes several data fields, each group of data fields corresponding to recent transactions for currency pairs in chronological order, as shown in FIG. 2. The fields include a buy/sell field 53, an amount field 54, a rate field 55, a secondary amount field 56, a deal number field 57, date and time fields 58, an aggregate field 59 and a value date field 60. The buy/sell field 53 indicates whether the transaction is a purchase or sale of the currency pair. The amount field 54 is the amount of the transaction in the selected base currency. The rate field 55 indicates the exchange rate at which the transaction was matched. The secondary amount field 56 describes the amount of the transaction in the secondary currency of the currency pair. A unique deal number associated with the deal is listed in the deal number field 57. The date and time fields 58 indicate the exact date and time the transaction was matched by the matching engine 22. The aggressor field 59 will contain a yes/no value which indicates whether the client was aggressive or passive on the trade. The value date field 60 contains the settlement date, which is the day upon which each party in the trade must deliver the respective amount of currency.

The credit screen 28 includes a maximum credit exposure field 62, an actual credit exposure field 63 and an available credit exposure field 64. The maximum credit exposure field 62 indicates the limit of credit extended to the trader by the trader's bank. Actual credit exposure is the credit exposure from the current positions of the trader and is displayed in the actual credit exposure field 63. The available credit exposure field 64 is configured to list the difference between fields 62 and 63, which is the amount of credit that the trader may use in future deals. Any transactions that exceed these amounts will be blocked by the matching engine 22.

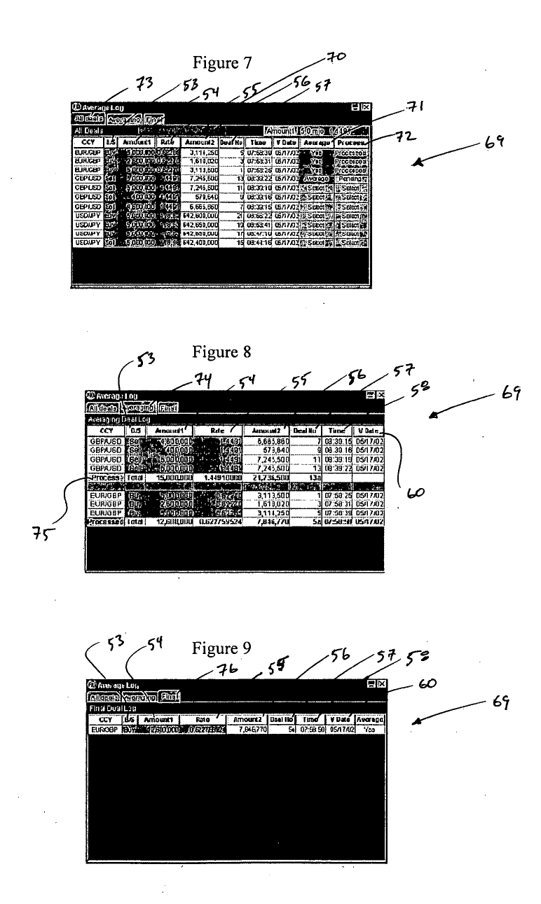

Selection of a functions pull-down menu 68 (as shown in FIG. 2) reveals an option to open an average log screen 69, as shown in FIG. 7. The average log screen includes an all deals tab 73 configured to display some of the same fields as the deal log 27, including the buy/sell field 53, the amount field 54, the rate field 55, the secondary amount field 56, the deal number field 57, the time field 58 and the value date of the deal field 60.

In addition to these fields, the average log screen 69 includes a deals awaiting action listing 70, an average indicator field 71 and a processing status field 72. The deals awaiting action listing 70 is configured to display the number of deals that have been matched by the matching engine 22 but have not yet been included in an averaging or designated as individual trades. In the average indicator field 71, deals are described as either “select,” indicating that the deal is capable of selection for averaging, “average,” indicating that the deal has been selected for averaging and “yes,” indicating that the deal was processed using the averaging function. In the processing status field 72, deals can be described as “select,” meaning the deal has not yet been processed and is selectable for averaging, “pending,” meaning that the deal has been selected for averaging and “processed,” meaning that the deal has been processed.

Selection of the “select” indicator in the average indicator field 71 changes the indicator to “average,” which prepares the deal for processing on an averaging tab 74 of the average log screen 69, as shown in FIG. 8. The averaging tab 74 of the average log screen 69 includes trades ready for processing grouped by currency pair and whether they are buy, or sell, transactions. A process selection field 75 is associated with an averaged transaction that includes a new deal number (which in the illustrated embodiment is the number of the latest deal with an appended a, e.g., “13a”) in the deal number field 57, the average rate in the rate field 55 and the total amount of all of the deals in the primary and secondary amount fields 54, 56.

Selection of the process selection field 75 then submits the deals to the settlement system 17 for processing either as a batch for the entire amount at the average price, or alternatively, for processing singly in the original deal amounts but at the new, averaged price. Notably, because the bank is the intermediary that books the trades with other banks, the trader is free to batch averaged trades for clearance regardless of whether bank or trade with which the deal has been made is the same for all deals. In addition, the alternative of processing of the trades singly, but at the averaged price simplifies clearance while still allowing the identity of the original trades to be documented and maintained. Regardless of how the trade is processed, a final tab 76 of the average log screen 69 lists the processed trades in batched, averaged form for simplicity, as shown in FIG. 9.

A trading platform 13 of another embodiment of the present invention is shown in FIG. 14. The trading platform includes a processor 77 that communicates with other elements within the trading platform, or the computerized trading system 10, via a system interface or bus 78. Also included in the trading platform 13 is a display device/input device 79 for receiving and displaying data. The display device/input device may be, for example, a keypad or pointing device that is used in combination with a display screen. The trading platform 13 further includes memory 80, which preferably includes both read only memory (ROM) 81 and random access memory (RAM) 82. The ROM 81 is used to store a basic input/output system (BIOS) 83, containing the basic routines that help to transfer information between elements within the trading platform 13.

In addition, trading platform 13 includes at least one storage device 84, such as a hard disk drive, a floppy disk drive, a CD-ROM drive, or optical disk drive, for storing information on various computer-readable media, such as a hard disk, a removable magnetic disk, or a CD-ROM drive, or optical disk drive, for storing information on various computer-readable media, such as a hard disk, a removable magnetic disk, or a CD-ROM disk. As will be appreciated by one of ordinary skill in the art, each of these storage devices 84 is connected to the system bus 78 by an appropriate interface. The storage devices 84 and their associated computer-readable media provide non-volatile storage for the trading platform 13. It is important to note that the computer-readable media described above could be replaced by any other type of computer readable media known in the art. Such media include, for example, magnetic cassettes, flash memory cards, digital video disks, and Bernoulli cartridges.

A number of program modules may be stored by the various storage devices, such as within RAM 82 (as shown in FIG. 14) or within the storage device 84 (as not shown for clarity). Such program modules include an operating system 85, a bid/offer recording module 86, an automated bid/offer detection module 87, a bank trader detection module 88, a price matching module 89, a dual side automated bid/offer detection module 90, a credit/margin checking module 91 and an unmatched quantity calculation module 92. The modules control certain aspects of the operation of the trading platform 13, as is described above, with the assistance of the processor 77 and the operating system 85. While described as separate modules, these functions may, instead, be integrated.

Also located within the trading platform 13, is a system interface 93 for interfacing and communicating with other elements of the computerized trading system 10. It will be appreciated by one of ordinary skill in the art that one or more of the computerized trading system's components may be located geographically remotely from other computerized trading system components. Furthermore, one or more of the components may be combined, and additional components performing functions described herein may be included in the computerized trading system.

Various figures of the present application include block diagrams, flowcharts and control flow illustrations of methods, systems and program products according to the invention. It will be understood that each block or step of the block diagram, flowchart and control flow illustration, and combinations of blocks in the block diagram, flowchart and control flow illustration, can be implemented by computer program instructions. These computer program instructions may be loaded onto, or otherwise executable by, a computer or other programmable apparatus to produce a machine, such that the instructions which execute on the computer or other programmable apparatus create means for implementing the functions specified in the block diagram, flowchart or control flow block(s) or step(s).

These computer program instructions may also be stored in a computer-readable memory that can direct a computer or other programmable apparatus to function in a particular manner, such that the instructions stored in the computer-readable memory produce an article of manufacture including instruction means which implement the function specified in the block diagram, flowchart or control flow block(s) or step(s). The computer program instructions may also be loaded onto a computer or other programmable apparatus to cause a series of operational steps to be performed on the computer or other programmable apparatus to produce a computer implemented process such that the instructions which execute on the computer or other programmable apparatus provide steps for implementing the functions specified in the block diagram, flowchart or control flow block(s) or step(s).

Accordingly, blocks or steps of the block diagram, flowchart or control flow illustration support combinations of means for performing the specified functions, combinations of steps for performing the specified functions and program instruction means for performing the specified functions. For example, FIG. 1 shows the GUI generator 23 for generated the various GUIs illustrated herein, the matching engine 22 for matching bids and offers and the automated price feed generator 16 for automatically generating a feed of bids and offers. It will also be understood that each block or step of the block diagram, flowchart or control flow illustration, and combinations of blocks or steps in the block diagram, flowchart or control flow illustration, can be implemented by special purpose hardware-based computer systems which perform the specified functions or steps, or combinations of special purpose hardware and computer instructions.

The present invention has many advantages. For example, the trade restricting system 21 inhibits, or blocks, trading on automated price feeds by other banks or other automated price feeds. Such selective control over bank trading and automated price feeds actually increases the liquidity and depth of the market for individual traders. In addition, blocking of bank-to-bank trading, particularly in the case of automated price feeds, provides an incentive for banks to provide automated price feeds, further increasing liquidity and depth of the trading platform. Providing for hit and lift of displayed bids and offers with a single, or double click facilitates quick and efficient trading for the traders, thereby speeding market transactions. Re-pricing of current bids or offers also facilitates quick, efficient entry of new bids and offers at new prices. The averaging function allows a trader to control booking of matched trades at averaged prices while still maintaining the integrity of the original trade details, which can be convenient for tax purposes and simplify determination of the effects of a day's trading. In addition, for a trader managing multiple accounts, averaging eliminates need to use randomized or other unbiased trade allocation schemes.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

1. A computerized trading system for facilitating transactions of financial instruments between a plurality of traders, said computerized trading system comprising:
a bid and offer recorder connected in communication with the traders and configured to record a plurality of bids and offers from the traders, each of the bids and offers having transaction information including at least a price, a quantity and a type of financial instrument;
a matching engine connected in communication with the bid and offer recorder and capable of receiving the bids and offers from the bid and offer recorder, said matching engine configured to compare the bids and offers and to match bids with offers using the price, quantity and type of financial instrument associated with each of the bids and offers; and
a trade restrictor connected in communication with the bid and offer recorder and the matching engine, wherein the trade restrictor is configured to receive the bids and offers from the bid and offer recorder, detect at least one of the bids and offers that is automated and restrict booking of the automated one of the bids and offers.

2. A computerized trading system of claim 1, wherein the transaction information also includes a source identity and wherein the trade restrictor is further configured to restrict booking of the automated bids and offers based on the source identity.

3. A computerized trading system of claim 2, wherein the trade restrictor is further configured to restrict booking of the automated bids and offers by restricting matching, by the matching engine, of bids and offers which are automated and which originate from a market maker as described by the source identity.

4. A computerized trading system of claim 3, wherein the transaction information of each of the bids and offers includes automation data indicating that the bid or offer is automated and wherein the trade restrictor is configured to find the automation data and to block matching, by the matching engine, of bids and offers when the automation data indicates one of the bids and one of the offers of a potential match are automated.

5. A computerized trading system of claim 3, wherein the transaction information includes cancellation data and wherein the trade restrictor is further configured to determine if the cancellation data requests cancellation of a previous bid or offer which indicates automation of the bid or offer of the potential match.

6. A computerized trading system of claim 1, wherein automated bids and offers are generated from an automated price feed of another trading platform.

7. A computerized trading system of claim 1, wherein the transaction information also includes re-price information configured to replace a price of a previous bid or offer.

8. A computerized trading system of claim 1, wherein the trade restrictor is configured to restrict booking of the automated bids and offers by restricting submission of the automated bids and offers to the bid and offer recorder by the traders.

9. A computerized trading system of claim 1, wherein the trade restrictor is configured to restrict booking of the automated bids and offers by restricting matching of the automated bids and offers by the matching engine.

10. A computerized trading system of claim 1, wherein the trade restrictor is configured to restrict booking of bids and offers only when both the bid and the offer of a potential match are automated.

11. A method of facilitating a transactions of financial instruments between a plurality of traders, the method comprising:
recording bids and offers from the traders, each of the bids and offers having transaction information including at least a price, a quantity and a type of financial instrument;
comparing the bids and offers and matching the bids and offers using the price, quantity and type of financial instrument associated with each of the bids and offers; and
detecting at least one of the bids and offers that is automated and restricting booking of the automated one of the bids and offers.

12. A method of claim 11, further comprising recording a source identity for each of the bids and offers and restricting booking of the automated bids and offers if the source identity is a market maker.

13. A method of claim 12, wherein restricting booking includes blocking matching of automated bids and offers.

14. A method of claim 13, wherein recording the bids and offers also includes recording automation data indicating that the bids and offers are automated and wherein detecting which of the bids and offers are automated includes detecting if the automation data indicates automation of the bids and offers.

15. A method of claim 12, further comprising recording cancellation data associated with the bids and the offers and wherein detecting which of the bids and offers are automated includes determining if the cancellation data requests cancellation of a previous bid or offer.

16. A computer program product for facilitating transactions of financial instruments between a plurality of traders, the computer program product comprising a computer-readable storage medium having computer-readable program code portions stored therein, the computer-readable program code portions comprising:
a first executable code portion for recording bids and offers from the traders, each of the bids and offers having transaction information including at least a price, a quantity and a type of financial instrument;
a second executable code portion for comparing the bids and offers and matching the bids and offers using the price, quantity and type of financial instrument associated with each of the bids and offers; and
a third executable code portion for detecting at least one of the bids and offers that is automated and restricting booking of the automated one of the bids and offers.

17. A computer program product of claim 16, further comprising a fourth executable code portion for recording a source identity for each of the bids and offers and restricting booking of the automated bids and offers if the source identity is a market maker.

18. A computer program product of claim 17, wherein restricting booking of the third executable code portion includes blocking matching of automated bids and offers.

19. A computer program product of claim 18, wherein recording the bids and offers of the first executable code portion also includes recording automation data indicating that the bids and offers are automated and wherein detecting which of the bids and offers are automated of the third executable code portion includes detecting if the automation data indicates automation of the bids and offers.

20. A computer program product of claim 17, further comprising a fifth executable code portion for recording cancellation data associated with the bids and the offers and wherein detecting which of the bids and offers are automated of the third executable code portion includes determining if the cancellation data requests cancellation of a previous bid or offer.
